(19) United States
(12) Patent Application Publication
(10) Pub. No.: US 2025/0274960 A1
(43) Pub. Date: Aug. 28, 2025

(54) SIDELINK INTER-UE COORDINATION SCHEME 2

(71) Applicant: Apple Inc., Cupertino, CA (US)

(72) Inventors: Hong He, San Jose, CA (US); Chunxuan Ye, San Diego, CA (US); Dawei Zhang, Saratoga, CA (US); Wei Zeng, Saratoga, CA (US); Zhibin Wu, Los Altos, CA (US); Haitong Sun, Saratoga, CA (US); Peng Cheng, Beijing (CN)

(21) Appl. No.: 18/859,919

(22) PCT Filed: Apr. 25, 2022
(86) PCT No.: PCT/CN2022/089073

§ 371 Date: Oct. 24, 2024

(51) Int. Cl. H04W 72/40; H04W 72/1268

(52) U.S. Cl. CPC H04W 72/40; H04W 72/1268

(57) ABSTRACT

The present disclosure is related to IUC schemes under the co-channel coexistence of NR sidelink and LTE sidelink and to the approaches to determine the potential collision and transmit an IUC indication signal notifying the determination of the potential collision. In one aspect, a first UE capable of both LTE sidelink and NR sidelink can be used as an assisting UE to coordinate NR and LTE sidelink transmissions and receptions of various UEs including a second UE as an assisted UE after receiving a resource reservation signal from the second UE. By introducing enhanced conflict determination and transmission scheme to the co-channel coexistence NR sidelink and LTE sidelink, flexibility, efficiency, and reliability of the sidelink communication are improved.

### FIELD

The present disclosure relates to the field of wireless communication systems, and to the enhancement of inter-UE coordination (IUC) for co-channel coexistence of NR sidelink and LTE sidelink.

### BACKGROUND

The increased use of mobile applications has resulted in much focus on developing wireless systems capable of delivering large amounts of data at high speed. Sidelink (SL) communication can be used to facilitate direct device-to-device communication and to bypass and offload the base station and enables a quick exchange of data over short time. Solutions for efficiency and reliability continue to evolve to include enhancements and new features.

NR V2X defines two resource allocation modes for sidelink communications. Mode 1 is a centralized scheduling approach, in which the base station schedules sidelink resources to be used by the UE for sidelink transmissions. Mode 1 applies to in-coverage scenarios in which the various UEs are inside the coverage of the base station. On the other hand, Mode 2 is a distributed scheduling approach, in which the UE autonomously determines sidelink transmission resources within configured or pre-configured sidelink resources. Mode 2 can be used to support in-coverage, partial-coverage, and out-of-coverage communication with no need for the UEs to be in the coverage area of the base station.

### BRIEF DESCRIPTION OF THE DRAWINGS

Some examples of circuits, apparatuses and/or methods will be described in the following by way of example only. In this context, reference will be made to the accompanying Figures.

FIG. 1 is a block diagram illustrating an architecture of a wireless system including UEs capable of sidelink co-channel coexistence inter-UE coordination, according to one aspect of the disclosure.

FIG. 2 is a message flow diagram illustrating an IUC scheme 2 transmitting process including co-channel coexistence of NR sidelink and LTE sidelink according to one aspect of the disclosure.

FIGS. 3-7 are diagrams illustrating various enhanced resource overlap conditions for determining a potential inter-UE transmission conflict according to aspects of the disclosure.

FIG. 8 is a block diagram illustrating an architecture of a wireless system including a user equipment (UE) coordinating sidelink communication of other UEs in accordance with some aspects.

FIG. 9 illustrates a block diagram of an apparatus employable at a user equipment (UE) or other network device (e.g., JoT device), according to various aspects described herein.

FIG. 10 illustrates example components of a device in accordance with some aspects.

FIG. 11 illustrates example interfaces of baseband circuitry in accordance with some aspects.

### DETAILED DESCRIPTION

The present disclosure is described with reference to the attached figures. The like reference numerals are used to refer to like elements throughout. The figures are not drawn to scale, and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

The Third Generation Partnership Project (3GPP) standardized using sidelink communication between user equipments (UEs) to extend coverage of a wireless systems. As highlighted in the background section, for Mode 2 in NR V2X, a UE selects radio resources of sub-channels and time slots to be used to communicate with another UE via sidelink without involving a base station. Mode 2 in NR V2X supports inter-UE coordination (IUC) schemes, in which IUC information is generated based on sensing results and resource reservations received by an assisting UE that coordinates resource selections of various UEs on NR sidelink.

Further, for new radio (NR) sidelink, a coexistence of long-term evolution (LTE) sidelink has been introduced to be concurrently used with NR sidelink. For example, for a vehicle use case, the LTE V2X sidelink may support basic active safety applications whereas the NR V2X may support more advanced applications such as communications for automated driving. A co-channel coexistence happens when a NR sidelink and a LTE sidelink use resources that are fully or partially overlapped time and frequency. It is desired to develop enhanced IUC schemes for the co-channel coexistence of NR sidelink and LTE sidelink.

Accordingly, the present disclosure is related to IUC schemes under the co-channel coexistence of NR sidelink and LTE sidelink and to the approaches to determine the potential collision and transmit an IUC indication signal notifying the determination of the potential collision. Specifically, a first UE capable of both LTE sidelink and NR sidelink can be used as an assisting UE to coordinate NR and LTE sidelink transmissions and receptions of various UEs including a second UE as an assisted UE after receiving a resource reservation signal from the second UE. By introducing enhanced conflict determination and transmission scheme to the co-channel coexistence NR sidelink and LTE sidelink, flexibility, efficiency, and reliability of the sidelink communication are improved. Notably, though the NR sidelink and LTE sidelink are discussed throughout disclosure, it is understood that the described aspects can apply to other current or future networks that benefit from the principles described herein, such as other 3GPP systems (e.g., Sixth Generation (6G)) system), IEEE 802.16 protocols (e.g., WMAN, WiMAX, etc.), or the like.

In one aspect, in case of co-channel coexistence of the NR sidelink and the LTE sidelink, the sensed resources of both the NR sidelink and the LTE sidelink are considered by the first UE to determine potential resource collision. Specifically, as an example, the first UE can be configured or preconfigured with resource pools for the LTE sidelink and the NR sidelink. The resource pools for the LTE sidelink and the NR sidelink may be overlapped in time and frequency. Then the first UE senses on the resources in the resource pools of the LTE sidelink and the NR sidelink during a sensing window to identify occupied and available resources. The first UE also receives a resource reservation signal from the second UE. Upon receiving the resource reservation signal from the second UE, the first UE determines a potential resource collision based on the received resource reservation message and the sensed resources in the resource pools of the NR sidelink and the LTE sidelink. The first UE then transmits an IUC indication signal to the second UE indicating the potential resource collision.

In a further aspect, various conditions may be used to determine the potential resource collision. One resource overlap condition Condition 2-A-1 is for the assisting UE, UE-A, to decide whether resources reserved by another UE, UE-C, are fully or partially overlapped in time and frequency with the resources indicated by the assisted UE, UE-B, and whether the measured RSRP satisfies a LTE RSRP threshold. The LTE RSRP threshold is defined and used to determine the potential resource collision of the co-channel coexistence NR sidelink and LTE sidelink.

In one implementation, the LTE RSRP threshold is based on a data priority of the second UE and a data priority of the one or more other UEs. In some cases, the LTE RSRP threshold may be a list configured per resource pool. The RSRP threshold for NR and LTE conflicts may be separately defined or correlated from one another. In an alternative implementation, the LTE RSRP threshold is (pre) configured independent of data priority. The independent (pre)configured LTE RSRP threshold is simple to implement while a priority related LTE RSRP threshold provides more accurate inter-UE coordination and thus improves latency and efficiency. More details of the LTE RSRP threshold definition will be discussed below associated with various figures.

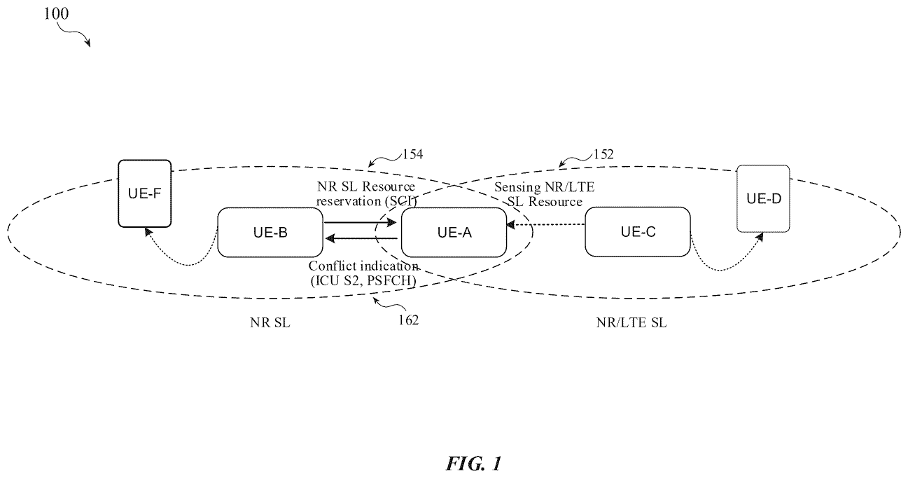

FIG. 1 is a block diagram illustrating an architecture of a wireless communication system 100 including multiple UEs (e.g., UE-A, UE-B, UE-C . . . collectively referred to as “UEs” or “UE”) capable of inter-UE coordination of sidelink co-channel coexistence according to some aspects of the disclosure. As shown in FIG. 1, a first UE UE-A receives a NR sidelink resource reservation information from a second UE UE-B, as shown by act 154. Then UE-A determines whether a potential resource conflict is presented or expected based on the resource reservation information received from UE-B and resource occupations of UE-A itself and/or other UEs such as a third UE UE-C. The resource occupations of other UEs may be obtained by sensing sidelink resources including NR sidelink resources and other sidelink resources such as co-channel coexistence LTE sidelink resources as shown by act 152. After the determination, UE-A may send an IUC indication signal to UE-B to indicate the presence of potential resource conflict, as shown by act 162. Absent the IUC indication signal, UE-B may transmit NR sidelink message as scheduled. Upon receiving the IUC indication signal, UE-B may cancel the resource reservation and cease to transmit using the previously reserved resources.

Thus, a condition to determine whether a potential resource conflict is presented or expected controls resource competition of UE-B with other UEs such as UE-A or UE-C. In various aspects, UE-A may or may not be a destination UE of UE-B or UE-C. For example, another UE UE-D may be the destination UE of a LTE sidelink transmission of UE-C while UE-A is the destination UE of the NR sidelink transmission of UE-B. Then the condition to determine whether a potential resource conflict is based on a RSRP measurement of the LTE resource reserved by UE-C. Further, an additional UE UE-F may be a destination UE of a sidelink transmission of UE-B while UE-A is the destination UE of the LTE sidelink transmission of UE-C. Then the condition to determine whether a potential resource conflict is based on a RSRP measurement of the NR resource reserved by UE-B.

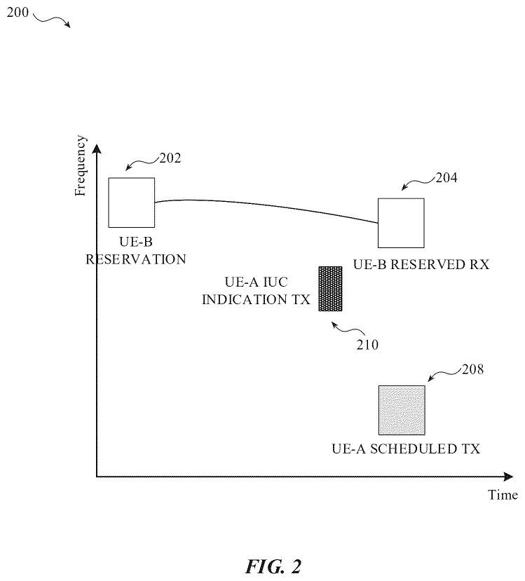

FIG. 2 is a message flow diagram illustrating an IUC scheme 2 transmitting process including co-channel coexistence of NR sidelink and LTE sidelink according to one aspect of the disclosure. As described in more details in sequenced acts below, a first UE (UE-A) can assist other UEs in selecting their sidelink resources by determining a potential resource collision based on sensing results of NR sidelink and LTE sidelink and a received resource reservation message. If the potential resource collision is determined and indicated to an assisted second UE (UE-B), the resource reservation is withdrawn such that UE-B ceases to transmit on the NR sidelink. Thus, the assisting UE-A coordinates a NR sidelink resource allocation of the assisted UE-B by considering the resource allocations of other UE's NR sidelink and LTE sidelink that are overlapped in time and frequency.

At act 202, sidelink resource pools are (pre) configured either via signaling message from a network or preconfigured in UE-A. A sidelink resource pool consists of time slots and frequency sub-channels allocated for sidelink transmission. The sub-channels are used to transmit data and control information. Such data is transmitted in transport blocks (TBs) over physical sidelink shared channels (PSSCH), and the control information is transmitted in sidelink control information (SCI) messages over physical sidelink control channels (PSCCH). UE-A can be (pre) configured by with multiple resource pools for transmission and with multiple resource pools for reception. UE-A can then transmit data on transmission resource pools and receive data from other UEs on reception resource pools.

In one aspect, configurations of resource pools for both new radio (NR) sidelink and long-term evolution (LTE) sidelink are obtained. The NR sidelink and the LTE sidelink may be coexisted in a co-channel and have resources overlapped in time and frequency. For example, The NR sidelink and the LTE sidelink may both be operated at frequencies around 5.9 GHZ within overlapped frequency bands. In this case, the (pre)configuration and selection of resources for LTE sidelink and NR sidelink may affect one another, and a coordination is needed between the two, since the interference may be of significance if two transmissions or two receptions are overlapped with sufficiently influential transmission power.

At act 204, UE-A senses on the resources in the NR resource pool. The sensing may occur in a sensing window, during which the SCI messages received from other UEs are decoded and a sidelink measurements (e.g., reference signal received power (RSRP)) is performed. The decoded SCI message indicates the sidelink resources that other UEs have reserved for their TBs in the PSSCH. In particular, the SCI message may indicate the sidelink resources reserved for retransmissions of the TB associated to the SCI message, and resources reserved for the initial transmission and retransmissions of the next SCI messages and TBs. UE-A also measures the RSRP of the transmissions associated to the SCI messages received from other UEs. As an example, UE-A may measure PSSCH-RSRP over DM-RS resource elements for the PSSCH or PSCCH-RSRP over DM-RS resource elements for the PSCCH according to the received SCI message. The UE stores the sensed information (the decoded SCI and the RSRP measurements) and uses it to determine which candidate resources should be excluded when a new selection or exclusion is triggered.

In one aspect, for NR sidelink sensing, the SCI message may be split in two stages with a first stage carried on the PSCCH while a second stage carried on the PSSCH. If UE-A is an assisting UE for another UE's resource selection but not the destination receiver of another UE, UE-A may decode the first stage SCI message for sensing and determining the resources reserved by other transmissions. On the other hand, when UE-A is the receiver UE of another UE, the second stage SCI message is also decoded for receiving the followed TB transmission. The two-stage SCI system supports unicast and groupcast transmission in addition to the broadcast transmission the one-stage SCI system (e.g. of a LTE sidelink system) supports.

At act 206, UE-A also senses on the resources in the LTE resource pool. A procedure similar as discussed above associated with act 204 can be performed during a sensing window of the LTE resource pool. The SCI messages received from other UEs are decoded and a sidelink measurement (e.g., reference signal received power (RSRP)) is performed. The decoded SCI message indicates the sidelink resources that other UEs have reserved for their TBs in the PSSCH. In particular, the SCI message may indicate the sidelink resources reserved for retransmissions of the TB associated to the SCI message, and resources reserved for the initial transmission and retransmissions of the next SCI messages and TBs. UE-A also measures the RSRP of the transmissions associated to the SCI messages received from other UEs. As an example, UE-A may measure PSSCH-RSRP over DM-RS resource elements for the PSSCH according to the received SCI message. The UE stores the sensed information (the decoded SCI and the RSRP measurements) and uses it to determine which candidate resources should be excluded when a new selection or exclusion is triggered. UE-A may decode the SCI message received from another UE to obtain the resource scheduling information of another UE, regardless whether UE-A is the receiver UE of the another UE.

At act 208, a resource reservation message is received on the NR sidelink from a second UE, UE-B. The resource reservation message indicates resources the second UE selects or reserves for future transmission of a sidelink message. UE-B may also send the resource reservation message to other neighboring UEs. The resource reservation message may be a first stage SCI message.

At act 210, a potential resource collision is evaluated and determined based on the received resource reservation message and the sensed resources in the resource pools of the NR sidelink and the LTE sidelink. Some example conditions for determining the potential resource collision will be discussed in details below.

At act 212, an inter-UE coordination (IUC) indication signal may be transmitted to UE-B in response to the resource reservation message indicating that the potential resource collision is determined. In one implementation, the IUC indication signal is transmitted on physical sidelink feedback channel (PSFCH). In one aspect, UE-A transmits the IUC indication signal upon determining the potential resource collision. In an alternative aspect UE-A selectively transmits the IUC indication signal based on the priority level of UE-B's data, the priority level of other conflicting UE's data, the timeline restriction, and UE-B's capability of receiving IUC information. For example, even if the potential resource collision is determined, the IUC indication signal may not be transmitted to UE-B if UE-B's data has a higher priority level than other UE's reservation. Thus, UE-B can occupy resources and transmit sidelink signal on NR sidelink even if the resources have been already reserved by another UE, if the second UE has a higher priority traffic. Then UE-A may cancel transmission of other conflicting UEs. For example, UE-A may transmit an IUC indication signal to the other conflicting UE to cancel the LTE sidelink resource reservation of that UE. If UE-B′s reservation conflicts with a scheduled transmission of UE-A, UE-A may cancel its own LTE sidelink resource reservation, so that it can receive UE-B's sidelink transmission on the reserved resource.

At act 214, optionally, UE-B may transmit on NR sidelink as scheduled if the IUC indication signal is not received. In one aspect, UE-A is the destination UE of the sidelink message and receives the sidelink message from UE-B. In another aspect, UE-B transmits the NR sidelink message to another destination UE as scheduled. On the other hand, UE-B may cancel resource reservation and not transmit the NR sidelink message using the previously reserved resource if the IUC indication signal is received. Then UE-B may reserve a different transmission resource.

As discussed above, the potential resource collision is determined based on the received resource reservation message together with UE-A′s resource allocation and/or previously obtained sensing results. Various conditions may be used to determine the potential resource collision. One resource overlap condition Condition 2-A-1 is for the assisting UE, UE-A, to decide whether resources reserved by another UE, UE-C, are fully or partially overlapped in time and frequency with the resources indicated by the assisted UE, UE-B, and whether the measured RSRP satisfies a RSRP threshold. The resources reserved by UE-C may be a co-channel coexistence LTE sidelink resource.

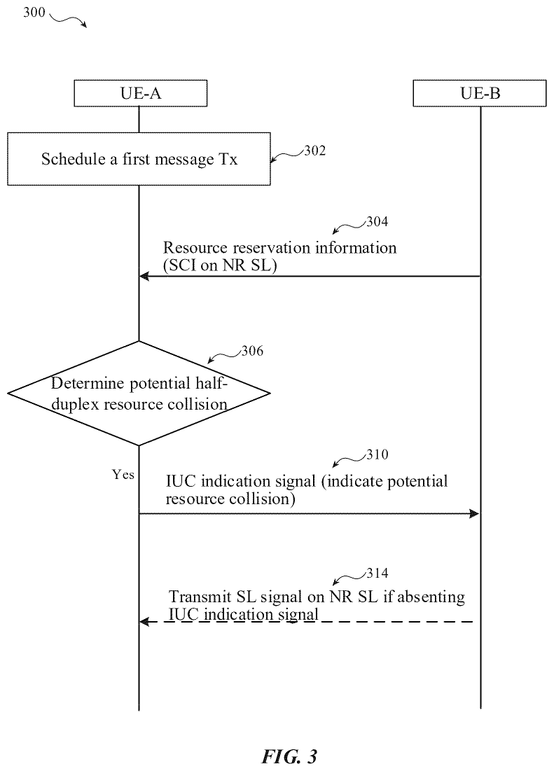

FIG. 3 is a diagram illustrating an enhanced condition for determining a potential inter-UE transmission conflict for co-channel coexistence LTE sidelink and NR sidelink according to one aspect of the disclosure. As shown in FIG. 3, in some implementations, a transmission of a first TB may be scheduled on a LTE sidelink from UE-C to another destination UE UE-D. UE-A can be a receiver UE of a second TB transmitted from UE-B and an IUC assisting UE to coordinate NR sidelink transmission of UE-B and LTE sidelink transmission of UE-C. During a sensing window, as shown and discussed associated with act 206 of FIG. 2, UE-A senses a LTE sidelink resource reservation information through a SCI message and a RSRP measurement from UE-C for a LTE sidelink transmission scheduled for a destination UE, UE-D. The reservation may be indicated by a SCI message. As shown and discussed associated with act 208 of FIG. 2, UE-A also receives a NR sidelink resource reservation from UE-B.

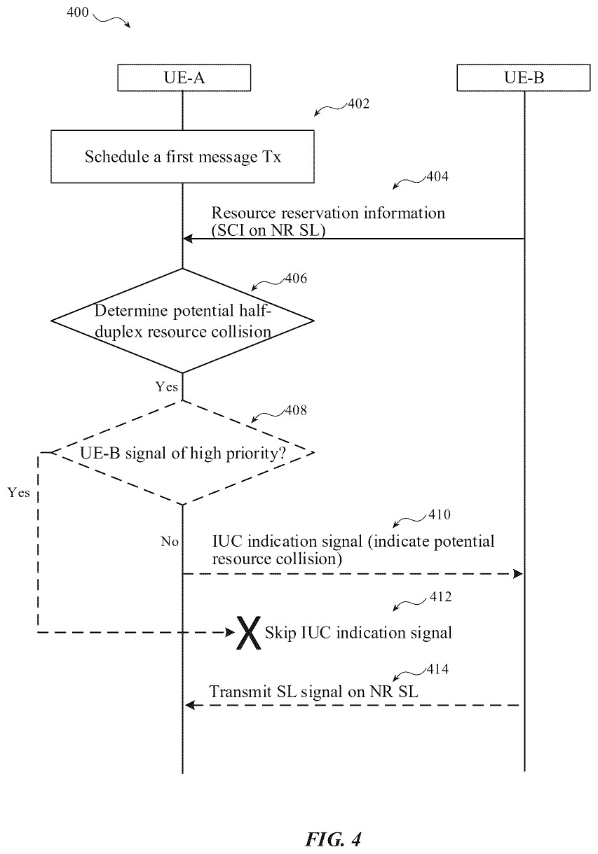

As a resource example shown in FIG. 4, a LTE resource, which occupies a sub-channel (e.g., SC2) and a slot or sub-frame (e.g. S4) can be used or reserved for LTE sidelink transmission by UE-C. A NR resource, which occupies a sub-channel (e.g., SC1) and a slot (e.g. S4) can be reserved by UE-B to transmit the second TB to UE-A. The LTE resource and the NR resource are overlapped in time-and frequency. Then a RSRP measurement is compared with a RSRP threshold to determine a potential collision.

In one implementation, a RSRP measurement of the LTE sidelink resources for UE-C is compared with a LTE RSRP threshold to determine a potential collision. The LTE RSRP threshold may be (pre)configured as a constant value independent of data priority. Alternatively, the LTE RSRP threshold may be (pre)configured based on a data priority of the second TB of UE-B and a data priority of the first TB of UE-C. The LTE RSRP threshold may be listed corresponding to various data priority value combinations as RSRP_{TH_LTE} (prio_Tx, prio_Rx), where prio_Tx is the data priority of UE-B, and prio_Rx is the data priority of UE-C. RSRP_{TH_LTE} may be independently configured per resource pool from a NR RSRP threshold list. Further alternatively, the RSRP_{TH_LTE} may be the same as the NR RSRP threshold list for simplicity. Further, RSRP_{TH_LTE} may be based on the NR RSRP threshold list plus a (pre) configured RSRP offset or a (pre)configured list of RSRP offsets. By (pre)configuring the LTE RSRP threshold or the LTE RSRP threshold list using the existing NR RSRP threshold or NR RSRP threshold list and adding an offset or an offset list, NR sidelink and LTE sidelink can be more tightly coordinated among UEs, and thus efficiency and reliability are improved.

In another implementation, a difference of a first RSRP measurement of UE-C, RSRP_{C}, and a second RSRP measurement of UE-B, RSRPB, is compared with a LTE relative RSRP threshold RSRP_{TH_delta_LTE} to determine the potential collision. The LTE relative RSRP threshold RSRP_{TH_delta_LTE} can be (pre)configured as a constant value independent of data priority. Alternatively, the LTE relative RSRP threshold RSRP_{TH_delta_LTE} may be (pre)configured based on a data priority of the second TB of UE-B and a data priority of the first TB of UE-C. The LTE relative RSRP threshold RSRP_{TH_delta_LTE} (i.e., RSRPc-RSRPB) may be listed corresponding to various data priority value combinations as RSRP_{TH_delta_LTE} (prio_Tx, prio_Rx), where prio_Tx is the data priority of the second TB of UE-B, and prio_Rx is the data priority of the first TB of UE-C. RSRP_{TH_ delta_LTE} may be configured per resource pool independently from a NR relative RSRP threshold list. Alternatively, the RSRP_{TH_delta_LTE} may be the same as the NR relative RSRP threshold list RSRP_{TH_ delta} for simplicity. Further, RSRP_{TH_ delta_LTE} may be based on the NR relative RSRP threshold list plus a (pre)configured relative RSRP offset or a (pre)configured list of relative RSRP offsets.

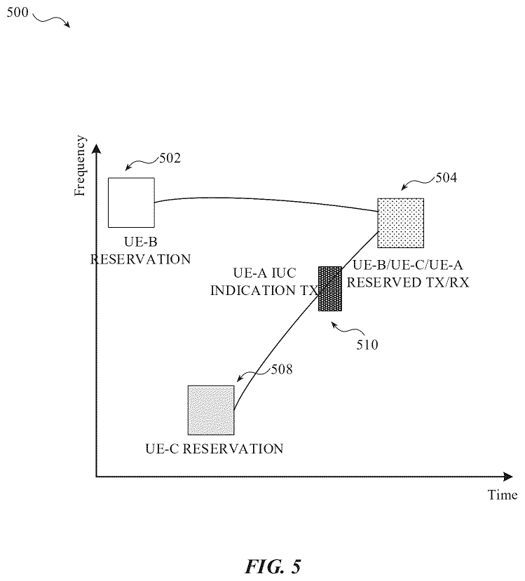

FIG. 5 is a diagram illustrating an enhanced condition for determining a potential inter-UE transmission conflict according to another aspect of the disclosure. As shown in FIG. 5, in some implementations, UE-A can be a receiver UE of a first TB transmitted on LTE sidelink from UE-C and an IUC assisting UE to coordinate NR sidelink transmission of UE-B and LTE sidelink transmission of UE-C. UE-A may not be a receiver UE of a second TB transmitted on NR sidelink from UE-B. The second TB may be scheduled to be transmitted to another destination UE UE-F.

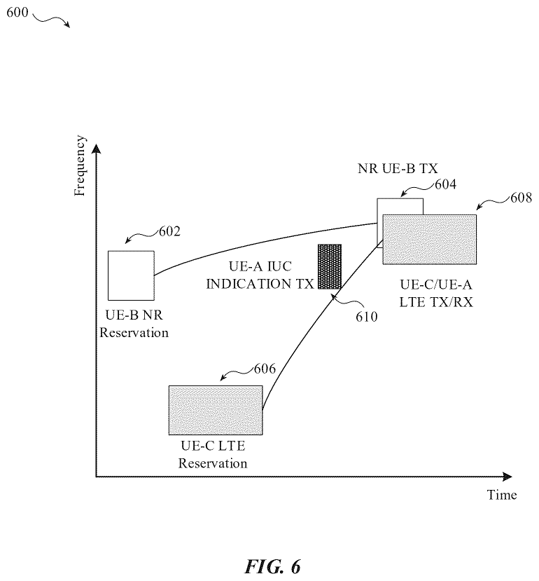

As an example shown in FIG. 6, a LTE resource, which occupies a sub-channel (e.g., SC2) and a slot (e.g. S4) can be used for LTE sidelink transmission from UE-C to UE-A. A NR resource, which occupies a sub-channel (e.g., SC1) and a slot (e.g. S4) can be reserved by UE-B to transmit a TB to another UE, UE-F. The LTE resource and the NR resource are overlapped in time-and frequency. Then a RSRP measurement of UE-B is compared with a RSRP threshold to determine the potential collision.

In one implementation, the LTE RSRP threshold is (pre) configured as a constant value independent of data priority. Alternatively, the LTE RSRP threshold is (pre)configured based on a data priority of the TB of UE-B and a data priority of the TB of UE-C. The LTE RSRP threshold may be listed corresponding to various data priority value combinations as RSRP_{TH_LTE} (prio_Tx, prio_Rx), where prio_Tx is the data priority of the first TB of UE-C, and prio_Rx is the data priority of the second TB of UE-B. RSRP_{TH_LTE} may be configured per resource pool independently from a NR RSRP threshold list. Further alternatively, the RSRP_{TH_LTE} may be the same as the NR RSRP threshold list for simplicity. Further, RSRP_{TH_LTE} may be based on the NR RSRP threshold list plus a (pre)configured RSRP offset or a (pre)configured list of RSRP offsets.

In another implementation, a difference of a first RSRP measurement of UE-B, RSRP_{B}, and a second RSRP measurement of UE-C, RSRP_{C}, is compared with a LTE relative RSRP threshold RSRP_{TH_delta_LTE} to determine the potential collision. The LTE relative RSRP threshold RSRP_{TH_delta_LTE} can be (pre configured as a constant value independent of data priority. Alternatively, the LTE relative RSRP threshold RSRP_{TH_delta_LTE} may be (pre)configured based on a data priority of the second TB of UE-B and a data priority of the first TB of UE-C. The relative RSRP threshold RSRP_{TH_delta_LTE} (i.e., RSRP_{B}-RSRP_{C}) may be listed corresponding to various data priority value combinations as RSRPTH_delta_LTE (prio_Tx, prio_Rx), where prio_Tx is the data priority of UE-C, and prio_Rx is the data priority of UE-B. RSRP_{TH_delta_LTE} may be configured per resource pool independently from a NR relative RSRP threshold list. Alternatively, RSRP_{TH_ delta_LTE} may be the same as the NR relative RSRP threshold list RSRP_{TH_delta} for simplicity. Further, RSRP_{TH_delta_LTE} may be based on the NR relative RSRP threshold list plus a (pre)configured relative RSRP offset or a (pre)configured list of relative RSRP offsets.

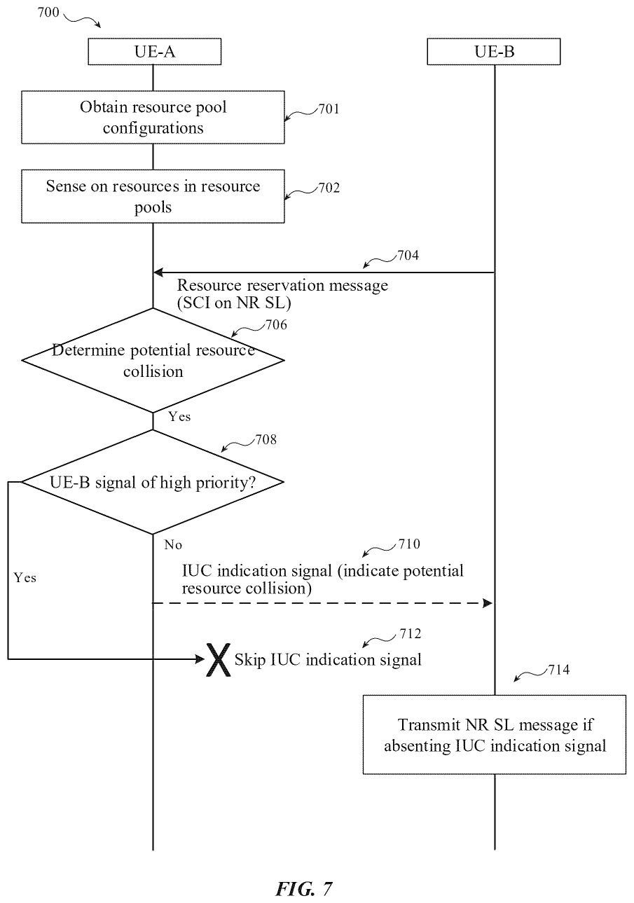

As shown and discussed associated with act 212 of FIG. 2, the IUC indication signal is transmitted from UE-A to UE-B to indicate that the potential resource collision is determined, if the enhanced condition to determine the potential resource collision is met. In some aspects, the IUC indication signal is configured to indicate that the potential resource collision is due to LTE sidelink conflict. If the potential resource collision is due to LTE sidelink conflict, UE-B may also consider additional subsequent slot(s) as conflicted with LTE sidelink. More details will be discussed below associated with FIG. 7.

The indication of the source of collision (i.e., whether the potential resource collision is due to LTE sidelink or NR sidelink conflict) can be transmitted separately or combined. In one implementation, the indication of the source of collision can be transmitted separately. For example, in one aspect, different cyclic shift values may be used to generate PSFCH sequence to indicate whether the collision is due to LTE sidelink or NR sidelink. In another aspect, different PSFCH frequency resources may be used to indicate whether the collision is due to LTE sidelink or NR sidelink.

In an alternative implementation, the indication that the potential resource collision is due to LTE sidelink conflict can be jointly communicated with the indication that the potential resource collision is due to NR sidelink conflict. For example, in one aspect, the IUC indication signal on PSFCH may include two bits information to indicate whether the collision is from LTE sidelink, NR sidelink, or either LTE sidelink or NR sidelink. More specifically, three cyclic shift values may be used to generate three PSFCH sequences to indicate whether the collision is from LTE sidelink, NR sidelink, or either LTE sidelink or NR sidelink. In another aspect, the IUC indication signal on PSFCH may include a single bit information to indicate whether the collision is from LTE sidelink or NR sidelink. More specifically, a cyclic shift values may be used to generate a PSPCH sequence to indicate whether the collision is from LTE sidelink or NR sidelink. In another further aspect, single bit information by two PSFCH sequences may be used to indicate whether the collision is from NR sidelink or whether the collision is from either LTE sidelink or NR sidelink.

FIG. 7 is a diagram illustrating an enhanced condition for determining a potential inter-UE transmission conflict according to another aspect of the disclosure. In cases where the potential collision is due to LTE sidelink, in some aspects, upon receiving the IUC indication signal, UE-B not only should skip using the reserved resource, but also should skip one or more following resources, considering a LTE transmission may occupy at least more than one slots. For example, as shown in FIG. 7, if UE-A determines that UE-B should not transmit on a NR resource (e.g., SC1, S4) due to the collision of a LTE resource (e.g., SC2, S4), then one or more next resources of the same sub-channel and subsequent in time (e.g. SC1, S5) should also be skipped. Similar as discussed above, the determination is based on a NR sidelink resource reservation information transmitted from UE-B and sensing results of LTE or NR sidelink resources from UE-C. UE-A can be a destination UE of UE-B while UE-C's destination UE is another UE, UE-D. Alternatively, UE-A can also be a destination UE of UE-C while UE-B′s destination UE is another UE, UE-F.

In some aspects, UE-B may consider different numerologies of LTE sidelink and NR sidelink to avoid (re)select the resources of the same LTE sidelink resource reservation. Specifically, in some aspects, the IUC indication signal may also indicate a resource collision of one or more slots subsequent to the reserved resource if the collision of reserved resource is due to LTE sidelink. Alternatively, the IUC indication signal may indicate a resource collision of the reserved resource, and that the resource collision is due to LTE sidelink. Upon receiving the indication that the resource collision is due to LTE sidelink, UE-B may consider the same sub-channel in the next one or more slots also as reserved by LTE sidelink based on the numerology, even without such an explicit indication by the IUC indication signal. As an example, one subframe has two slots if a subcarrier spacing (SCS) (numerology) of 30 kHz is used. In this case, the same sub-channel in the next slot is also considered as reserved by LTE sidelink. As another example, one subframe has four slots if a subcarrier spacing (SCS) (numerology) of 60 kHz is used. In this case, the same sub-channel in the next three slots is also considered as reserved by LTE sidelink.

Accordingly, the present disclosure provides various enhancements for inter-UE coordination for co-channel coexistence NR sidelink and LTE sidelink transmissions. In some aspects, an assisting UE determines and indicates a potential collision for a NR sidelink transmission of an assisted UE with a previously reserved LTE sidelink transmission of another UE. The potential collision may be determined based on a comparison of RSRP measurements of the related UEs with a RSRP threshold, which may be assigned, predefined, (pre)configured based on data priorities, or correlated with a current NR RSRP threshold. Other further enhancements of the IUC indication signal are also disclosed throughout the disclosure.

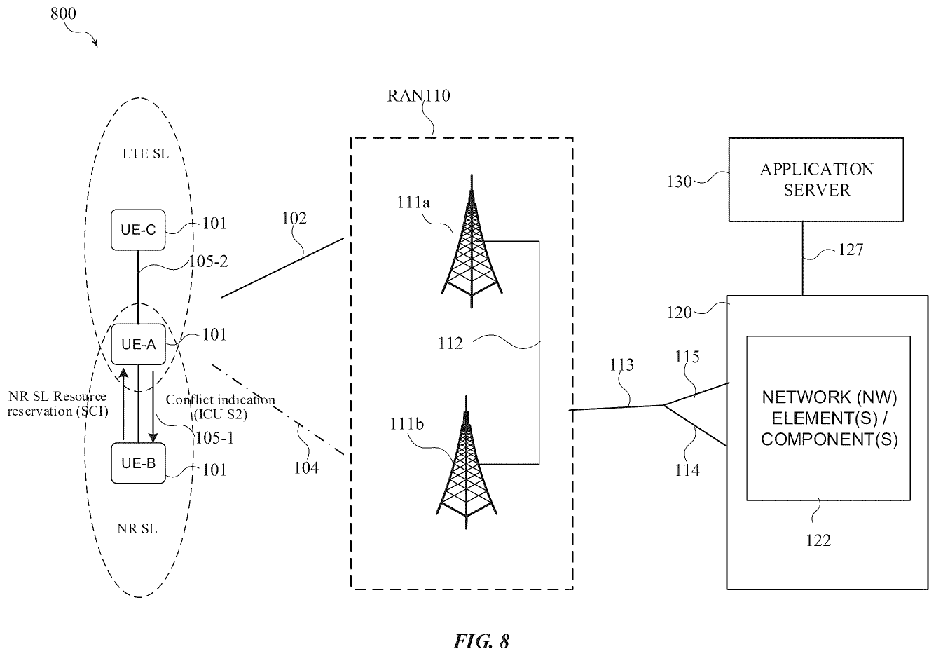

FIG. 8 is a block diagram illustrating an architecture of a wireless system 800 including an assisting UE UE-A coordinating sidelink communication of other UEs such as UE-B, UE-C in accordance with some aspects. The UEs are labeled and referred as UE 101 or UEs 101 for purpose of description below, which may include one or more of the assisting UE-A, assisted second UE UE-B, or other UEs such as UE-C, UE-D, UE-F as described throughout the disclosure, claimed in claims, and shown in other figures.

As shown by FIG. 8, the UEs 101 can be configured to connect, for example, communicatively couple, with a Radio Access Network (RAN) 110 utilizing connections (or channels) 102 and 104, which respectively comprise a physical communications channel/interface. The RAN 110 can include one or more RAN nodes, including base stations (BS) 111a and 111b (collectively referred to as “BS 111”), that enable the connections 102 and 104. In aspects, the UEs 101 can directly exchange communication data via a ProSe interface 105. The ProSe interface 105 can alternatively be or be referred to as a sidelink interface 105 and can comprise one or more logical channels, including but not limited to a physical sidelink control channel (PSCCH), a physical sidelink shared channel (PSSCH), a physical sidelink feedback channel (PSFCH), a physical sidelink discovery channel (PSDCH), and a physical sidelink broadcast channel (PSBCH). As described throughout the present disclosure, the assisted UE UE-B may transmit a NR sidelink resource reservation to the assisting UE UE-A. Then the assisting UE-A may determine a resource collision based on the received sidelink resource reservation and other LTE or NR resource scheduling and reservations. The assisting UE-A may indicate such a resource collision to the assisted UE-B if so determined according to various measurement and data priority assessment discussed in details.

The UEs 101 can be or be comprised of any mobile or non-mobile computing device, such as consumer electronics devices including headset, handset, cellular phones, smartphones, feature phones, tablet computers, wearable computer devices, personal digital assistants (PDAs), pagers, wireless handsets, desktop computers, laptop computers, vehicles, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

In some aspects, the RAN 110 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN 110 that operates in an NR or 5G wireless system, and the term “E-UTRAN” or the like can refer to a RAN 110 that operates in a long-term evolution (LTE) or 4G system. In this example, the connections 102 and 104 are illustrated as an air interface to enable communicative coupling and can be consistent with cellular communications protocols, such as a Global System for Mobile communications (GSM) protocol, a Code-Division Multiple Access (CDMA) network protocol, a Push-to-Talk (PTT) protocol, a PTT over-cellular (POC) protocol, a Universal Mobile Telecommunications Service (UMTS) protocol, a 3GPP LTE protocol, a 5G protocol, an NR protocol, and/or any of the other communications protocols discussed herein. The BS 111a, 111b may be configured to communicate with one another via an interface 112. In implementations where the system is a 5G or NR system, the interface 112 can be an Xn interface 112. The Xn interface is defined between two or more BS 111. In some implementations, the Xn interface can include an Xn user plane (Xn-U) interface and an Xn control plane (Xn-C) interface. The Xn-U can provide non- guaranteed delivery of user plane PDUs and support/provide data forwarding and flow control functionality. The Xn-C can provide management and error handling functionality, functionality to manage the Xn-C interface; mobility support for UE 101 in a connected mode (e.g., CM-CONNECTED) including functionality to manage the UE mobility for connected mode between one or more BS 111. As used herein, the terms “access node,” “access point,” or the like can describe equipment that provides the radio baseband functions for data and/or voice connectivity between a network and one or more users. These BS can be referred to as access nodes, gNBs, RAN nodes, eNBs, NodeBs, RSUs, Transmission Reception Points (TRxPs) or TRPs, and so forth, and can comprise ground stations (e.g., terrestrial access points) or satellite stations providing coverage within a geographic area (e.g., a cell). According to various aspects, the BS 111 can be implemented as one or more of a dedicated physical device such as a macrocell base station and/or a low power (LP) base station for providing femtocells, picocells, or other like cells having smaller coverage areas, smaller user capacity, or higher bandwidth compared to macrocells.

The RAN 110 is communicatively coupled to a core network (CN) 120. The CN 120 can comprise a plurality of network elements 122 configured to offer various data and telecommunications services to customers/subscribers (e.g., users of UEs 101) who are connected to the CN 120 via the RAN 110. In aspects, where the CN 120 is an EPC, the RAN 110 can be connected with the CN 120 via an S1 interface 113. In embodiments, the S1 interface 113 can be split into two parts, an S1 user plane (S1-U) interface 114, which carries traffic data between the BS 111 and the S-GW, and the S1-MME interface 115, which is a signaling interface between the BS 111 and MMEs.

An application server 130 can be an element offering applications that use IP bearer resources with the CN 120 via an Internet Protocol (IP) interface 127 (e.g., Universal Mobile Telecommunications System Packet Services (UMTS PS) domain, LTE PS data services, etc.). The application server 130 can also be configured to support one or more communication services (e.g., VoIP sessions, PTT sessions, group communication sessions, social networking services, etc.) for the UEs 101 via the CN 120. The application server 130 can signal the CN 120 to indicate a new service flow and select an appropriate QoS and charging parameters with the appropriate traffic flow template (TFT) and QoS class of identifier (QCI), which commences the QoS and charging as specified by the application server 130.

As the number of mobile devices within wireless networks and the demand for mobile data traffic continue to increase, changes are made to system requirements and architectures to increase communication capacity and speed. An aspect of such changes May include dual connectivity (DC), where a secondary node (SN) is utilized to provide additional resources to the UEs 101 while a master node (MN) provides control plane connection to the core network. The UEs 101 can be configured with DC as a multi-RAT or multi-Radio Dual Connectivity (MR-DC), where a multiple Rx/Tx capable UE may be configured to utilize resources provided by two different nodes that can be connected via non-ideal backhaul, one providing NR access and the other one providing either E-UTRA for LTE or NR access for 5G, for example. The MN and SN can be connected via a network interface, and at least the MN is connected to the CN 120. At least one of the MN or the SN can be operated with shared spectrum channel access. All functions specified for the UEs 101 can be used for integrated access and backhaul mobile termination (IAB-MT). Similar to the UEs 101, the IAB-MT can access the network using either one network node or using two different nodes with EN-DC architectures, NR-DC architectures, or the like. NR-DC is a DC configuration used in the 5G NR network, whereby both the MN and the SN are 5G gNBs. In EN-DC (Eutran NR Dual Connectivity), LTE would become an MCG (Master Cell Group), and NR would become an SCG (Secondary Cell Group).

In MR-DC, a group of serving cells associated with a master Node can be configured as a master cell group (MCG), comprising of a special cell (SpCell) as a primary cell (PCell) and optionally one or more secondary cells (SCells). An MCG can be the radio access node that provides the control plane connection to the core network (CN) 120; it may be a Master eNB (in EN-DC), a Master ng-eNB (in NGEN-DC), or a Master gNB (in NR-DC and NE-DC), for example. An SCG in MR-DC can be a group of serving cells associated with an SN, comprising the SpCell as a PSCell and optionally one or more SCells. Thus, SpCell can either refer to the PCell of the MCG or the primary secondary cell (PSCell) of a second cell group (SCG) depending on if the MAC entity is associated with the MCG or the SCG, respectively.

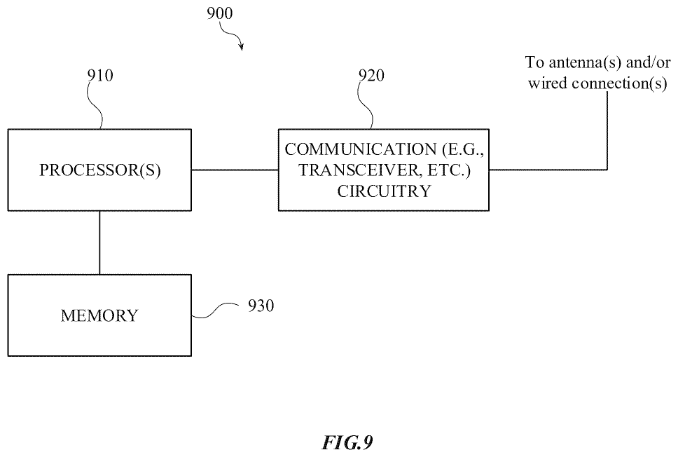

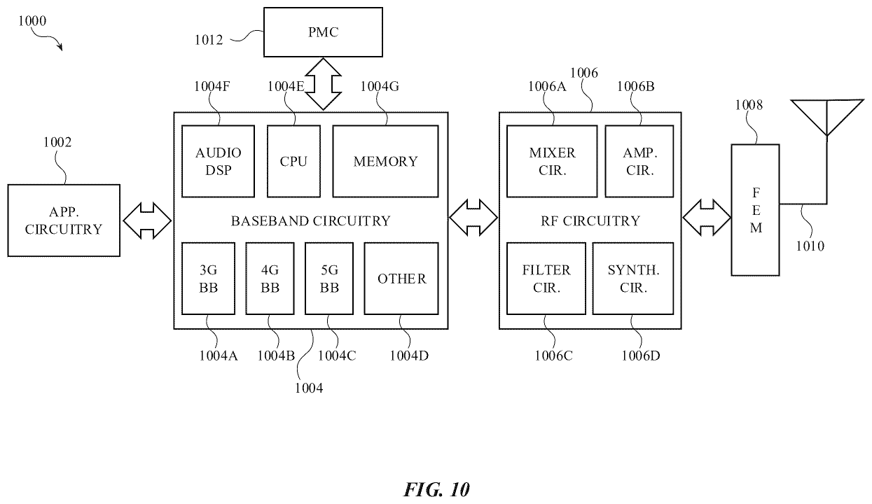

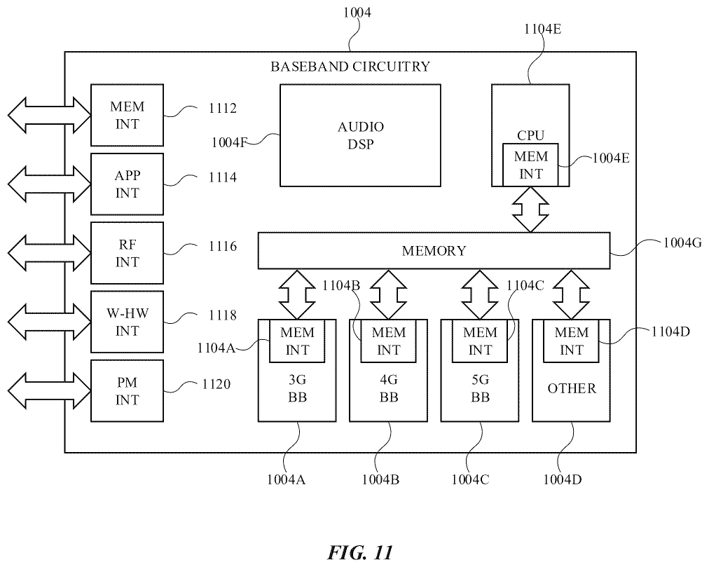

Referring to FIG. 9, illustrated is a block diagram of an apparatus 900 employable at a user equipment (UE) according to various aspects described herein. In some aspects, the apparatus 900 may be included within the assisting first UE UE-A, assisted second UE UE-B, or other UEs UE-C, UE-D, UE-F as described throughout the disclosure, claimed in claims, and shown in other figures. Apparatus 900 can include one or more processors 910 (e.g., one or more baseband processors such as one or more of the baseband processors discussed in connection with FIG. 10 and/or FIG. 11) comprising processing circuitry and associated interface(s) (e.g., one or more interface(s) discussed in connection with FIG. 11), transceiver circuitry 920 (e.g., comprising part or all of RF circuitry 1006, which can comprise transmitter circuitry (e.g., associated with one or more transmit chains) and/or receiver circuitry (e.g., associated with one or more receive chains) that can employ common circuit elements, distinct circuit elements, or a combination thereof), and a memory 930 (which can comprise any of a variety of storage mediums and can store instructions and/or data associated with one or more of processor(s) 910 or transceiver circuitry 920). In particular, the term memory is intended to include an installation medium, e. g., a CD-ROM, floppy disks, or tape device; a computer system memory or random access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium may comprise other types of memory as well or combinations thereof.

In various aspects discussed herein, signals and/or messages can be generated and output for transmission, and/or transmitted messages can be received and processed. Depending on the type of signal or message generated, outputting for transmission (e.g., by processor(s) 910) can comprise one or more of the following: generating a set of associated bits that indicate the content of the signal or message, coding (e.g., which can include adding a cyclic redundancy check (CRC) and/or coding via one or more of turbo code, low density parity-check (LDPC) code, tailbiting convolution code (TBCC), etc.), scrambling (e.g., based on a scrambling seed), modulating (e.g., via one of binary phase shift keying (BPSK), quadrature phase shift keying (QPSK), or some form of quadrature amplitude modulation (QAM), etc.), and/or resource mapping (e.g., to a scheduled set of resources, to a set of time and frequency resources granted for uplink transmission, etc.). Depending on the type of received signal or message, processing (e.g., by processor(s) 910) can comprise one or more of: identifying physical resources associated with the signal/message, detecting the signal/message, resource element group deinterleaving, demodulation, descrambling, and/or decoding. In some aspects, the one or more processors 910, the transceiver circuitry 920 and the memory circuit 930 may be implemented as part of a modem system on a single integrated circuit (IC). Alternately, in other aspects, the one or more processors 910, the transceiver circuitry 920 and the memory circuit 930 may be implemented on different ICs.

FIG. 10 illustrates example components of a device 1000 in accordance with some aspects. In some aspects, the device 1000 can include application circuitry 1002, baseband circuitry 1004, Radio Frequency (RF) circuitry 1006, front-end module (FEM) circuitry 1008, one or more antennas 1010, and power management circuitry (PMC) 1012 coupled together at least as shown. The components of the illustrated device 1000 can be included in a UE or a BS. In some aspects, the device 1000 can include fewer elements (e.g., a RAN node may not utilize application circuitry 1002, and instead include a processor/controller to process IP data received from a CN such as 5GC 720 or an Evolved Packet Core (EPC)). In some aspects, the device 1000 can include additional elements such as, for example, memory/storage, display, camera, sensor, or input/output (I/O) interface. In other aspects, the components described below can be included in more than one device (e.g., said circuitries can be separately included in more than one device for Cloud-RAN (C-RAN) implementations). In some aspects, the device 1000 may be, be comprised of, or be included within the assisting first UE UE-A, assisted second UE UE-B, or other UEs UE-C, UE-D, UE-F as described throughout the disclosure, claimed in claims, and shown in other figures.

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some aspects, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband processing circuity 1004 can interface with the application circuitry 1002 for generation and processing of the baseband signals and for controlling operations of the RF circuitry 1006. For example, in some aspects, the baseband circuitry 1004 can include a third generation (3G) baseband processor 1004A, a fourth generation (4G) baseband processor 1004B, a fifth generation (5G) baseband processor 1004C, or other baseband processor(s) 1004D for other existing generations, generations in development or to be developed in the future (e.g., second generation (2G), sixth generation (6G), etc.). The baseband circuitry 1004 (e.g., one or more of baseband processors 1004A-D) can handle various radio control functions that enable communication with one or more radio networks via the RF circuitry 1006. In other aspects, some or all of the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some aspects, modulation/demodulation circuitry of the baseband circuitry 1004 can include Fast-Fourier Transform (FFT), precoding, or constellation mapping/demapping functionality. In some aspects, encoding/decoding circuitry of the baseband circuitry 1004 can include convolution, tail-biting convolution, turbo, Viterbi, or Low Density Parity Check (LDPC) encoder/decoder functionality. Aspects of modulation/demodulation and encoder/decoder functionality are not limited to these examples and can include other suitable functionality in other aspects.

In some aspects, the baseband circuitry 1004 can include one or more audio digital signal processor(s) (DSP) 1004F. The audio DSP(s) 1004F can include elements for compression/decompression and echo cancellation and can include other suitable processing elements in other aspects. Components of the baseband circuitry can be suitably combined in a single chip, a single chipset, or disposed on a same circuit board in some aspects. In some aspects, some or all of the constituent components of the baseband circuitry 1004 and the application circuitry 1002 can be implemented together such as, for example, on a system on a chip (SOC).

In some aspects, the baseband circuitry 1004 can provide for communication compatible with one or more radio technologies. For example, in some aspects, the baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Aspects in which the baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various aspects, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some aspects, the receive signal path of the RF circuitry 1006 can include mixer circuitry 1006a, amplifier circuitry 1006b and filter circuitry 1006c. In some aspects, the transmit signal path of the RF circuitry 1006 can include filter circuitry 1006c and mixer circuitry 1006a. RF circuitry 1006 can also include synthesizer circuitry 1006d for synthesizing a frequency for use by the mixer circuitry 1006a of the receive signal path and the transmit signal path. In some aspects, the mixer circuitry 1006a of the receive signal path can be configured to down-convert RF signals received from the FEM circuitry 1008 based on the synthesized frequency provided by synthesizer circuitry 1006d. The amplifier circuitry 1006b can be configured to amplify the down-converted signals and the filter circuitry 1006c can be a low-pass filter (LPF) or band-pass filter (BPF) configured to remove unwanted signals from the down-converted signals to generate output baseband signals. Output baseband signals can be provided to the baseband circuitry 1004 for further processing. In some aspects, the output baseband signals can be zero-frequency baseband signals, although this is not a requirement. In some aspects, mixer circuitry 1006a of the receive signal path can comprise passive mixers, although the scope of the aspects is not limited in this respect.

In some aspects, the mixer circuitry 1006a of the transmit signal path can be configured to up-convert input baseband signals based on the synthesized frequency provided by the synthesizer circuitry 1006d to generate RF output signals for the FEM circuitry 1008. The baseband signals can be provided by the baseband circuitry 1004 and can be filtered by filter circuitry 1006c.

In some aspects, the mixer circuitry 1006a of the receive signal path and the mixer circuitry 1006a of the transmit signal path can include two or more mixers and can be arranged for quadrature downconversion and upconversion, respectively. In some aspects, the mixer circuitry 1006a of the receive signal path and the mixer circuitry 1006a of the transmit signal path can include two or more mixers and can be arranged for image rejection (e.g., Hartley image rejection). In some aspects, the mixer circuitry 1006a of the receive signal path and the mixer circuitry 1006a can be arranged for direct downconversion and direct upconversion, respectively. In some aspects, the mixer circuitry 1006a of the receive signal path and the mixer circuitry 1006a of the transmit signal path can be configured for super-heterodyne operation.

In some aspects, the output baseband signals and the input baseband signals can be analog baseband signals, although the scope of the aspects is not limited in this respect. In some alternate aspects, the output baseband signals and the input baseband signals can be digital baseband signals. In these alternate aspects, the RF circuitry 1006 can include analog-to-digital converter (ADC) and digital-to-analog converter (DAC) circuitry and the baseband circuitry 1004 can include a digital baseband interface to communicate with the RF circuitry 1006.

In some dual-mode aspects, a separate radio IC circuitry can be provided for processing signals for each spectrum, although the scope of the aspects is not limited in this respect. In some aspects, the synthesizer circuitry 1006d can be a fractional-N synthesizer or a fractional N/N+1 synthesizer, although the scope of the aspects is not limited in this respect as other types of frequency synthesizers can be suitable. For example, synthesizer circuitry 1006d can be a delta-sigma synthesizer, a frequency multiplier, or a synthesizer comprising a phase-locked loop with a frequency divider. The synthesizer circuitry 1006d can be configured to synthesize an output frequency for use by the mixer circuitry 1006a of the RF circuitry 1006 based on a frequency input and a divider control input. In some aspects, the synthesizer circuitry 1006d can be a fractional N/N+1 synthesizer.

In some aspects, frequency input can be provided by a voltage controlled oscillator (VCO), although that is not a requirement. Divider control input can be provided by either the baseband circuitry 1004 or the applications processor 1002 depending on the desired output frequency. In some aspects, a divider control input (e.g., N) can be determined from a look-up table based on a channel indicated by the applications processor 1002.

Synthesizer circuitry 1006d of the RF circuitry 1006 can include a divider, a delay-locked loop (DLL), a multiplexer and a phase accumulator. In some aspects, the divider can be a dual modulus divider (DMD) and the phase accumulator can be a digital phase accumulator (DPA). In some aspects, the DMD can be configured to divide the input signal by either N or N+1 (e.g., based on a carry out) to provide a fractional division ratio. In some example aspects, the DLL can include a set of cascaded, tunable, delay elements, a phase detector, a charge pump and a D-type flip-flop. In these aspects, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some aspects, synthesizer circuitry 1006d can be configured to generate a carrier frequency as the output frequency, while in other aspects, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some aspects, the output frequency can be a LO frequency (fLO). In some aspects, the RF circuitry 1006 can include an IQ/polar converter.

FEM circuitry 1008 can include a receive signal path which can include circuitry configured to operate on RF signals received from one or more antennas 1010, amplify the received signals and provide the amplified versions of the received signals to the RF circuitry 1006 for further processing. FEM circuitry 1008 can also include a transmit signal path which can include circuitry configured to amplify signals for transmission provided by the RF circuitry 1006 for transmission by one or more of the one or more antennas 1010. In various aspects, the amplification through the transmit or receive signal paths can be done solely in the RF circuitry 1006, solely in the FEM 1008, or in both the RF circuitry 1006 and the FEM 1008.

In some aspects, the FEM circuitry 1008 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1006). The transmit signal path of the FEM circuitry 1008 can include a power amplifier (PA) to amplify input RF signals (e.g., provided by RF circuitry 1006), and one or more filters to generate RF signals for subsequent transmission (e.g., by one or more of the one or more antennas 1010).

In some aspects, the PMC 1012 can manage power provided to the baseband circuitry 1004. In particular, the PMC 1012 can control power-source selection, voltage scaling, battery charging, or DC-to-DC conversion. The PMC 1012 can often be included when the device 1000 is capable of being powered by a battery, for example, when the device is included in a UE. The PMC 1012 can increase the power conversion efficiency while providing desirable implementation size and heat dissipation characteristics.

While FIG. 10 shows the PMC 1012 coupled only with the baseband circuitry 1004. However, in other aspects, the PMC 1012 may be additionally or alternatively coupled with, and perform similar power management operations for, other components such as, but not limited to, application circuitry 1002, RF circuitry 1006, or FEM 1008.

In some aspects, the PMC 1012 can control, or otherwise be part of, various power saving mechanisms of the device 1000. For example, if the device 1000 is in an RRC_Connected state, where it is still connected to the RAN node as it expects to receive traffic shortly, then it can enter a state known as Discontinuous Reception Mode (DRX) after a period of inactivity. During this state, the device 1000 can power down for brief intervals of time and thus save power.

If there is no data traffic activity for an extended period of time, then the device 1000 can transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down completely. Any data sent during this time incurs a large delay and it is assumed the delay is acceptable.

Processors of the application circuitry 1002 and processors of the baseband circuitry 1004 can be used to execute elements of one or more instances of a protocol stack. For example, processors of the baseband circuitry 1004, alone or in combination, can be used execute Layer 3, Layer 2, or Layer 1 functionality, while processors of the application circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

FIG. 11 illustrates example interfaces of baseband circuitry in accordance with some aspects. As discussed above, the baseband circuitry 1004 of FIG. 10 can comprise processors 1004A-1004E and a memory 1004G utilized by said processors. Each of the processors 1004A-1004E can include a memory interface, 1104A-1104E, respectively, to send/receive data to/from the memory 1004G.

The baseband circuitry 1004 can further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 802 of FIG. 2), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth® components (e.g., Bluetooth®) Low Energy), Wi-Fi® components, and other communication components), and a power management interface 1120 (e.g., an interface to send/receive power or control signals to/from the PMC 1012).

While the disclosure has been illustrated, and described with respect to one or more implementations, alterations and/or modifications may be made to the illustrated examples without departing from the spirit and scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure.

The above description of illustrated aspects of the subject disclosure, including what is described in the Abstract, is not intended to be exhaustive or to limit the disclosed aspects to the precise forms disclosed. While specific aspects and examples are described herein for illustrative purposes, various modifications are possible that are considered within the scope of such aspects and examples, as those skilled in the relevant art can recognize.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### EXAMPLES

Example 1 is a baseband processor for a first user equipment (UE), comprising one or more processors. The one or more processors are configured to obtain configurations of resource pools for a new radio (NR) sidelink and a long-term evolution (LTE) sidelink, wherein the NR sidelink and the LTE sidelink are coexisted in a co-channel and have resources overlapped in time and frequency; sense on the resources in the resource pools for both the NR sidelink and the LTE sidelink including transmission of a first transport block (TB); receive a resource reservation information on the NR sidelink from a second UE, the resource reservation information indicating NR resources reserved by the second UE for transmission of a second TB; determine a potential resource collision if the NR resources reserved by the second UE are fully or partially overlapped with LTE sidelink resources reserved by a third UE, and a reference signal received power (RSRP) measurement satisfies a LTE RSRP threshold; and transmit an inter-UE coordination (IUC) signal to the second UE indicating the potential resource collision is determined.

Example 2 is a baseband processor, including the subject matter of example 1, wherein the first UE is a destination UE of the second TB, and the potential resource collision is determined if a RSRP measurement of the reserved LTE sidelink resources of the third UE is larger than the LTE RSRP threshold.

Example 3 is a baseband processor, including the subject matter of example 2, 2, wherein the LTE RSRP threshold is (pre)configured independent of data priority.

Example 4 is a baseband processor, including the subject matter of example 2, wherein the one or more processors are further configured to obtain the LTE RSRP threshold based on a data priority of the second UE and a data priority of the third UE.

Example 5 is a baseband processor, including the subject matter of example 4, wherein the LTE RSRP threshold is (pre)configured per resource pool independently from a NR RSRP threshold list.

Example 6 is a baseband processor, including the subject matter of example 4, wherein the LTE RSRP threshold is (pre)configured per resource pool based on a NR RSRP threshold list.

Example 7 is a baseband processor, including the subject matter of example 6, wherein the LTE RSRP threshold is (pre)configured per resource pool based on a NR RSRP threshold list plus a (pre)configured RSRP offset or a (pre)configured list of RSRP offsets.

Example 8 is a baseband processor, including the subject matter of example 1, wherein the first UE is a destination UE of the first TB, wherein the potential resource collision is determined if a RSRP measurement of the reserved NR sidelink resources of the second UE is larger than the LTE RSRP threshold; and wherein the LTE RSRP threshold is based on a data priority of the second UE and a data priority of the third UE.

Example 9 is a baseband processor, including the subject matter of example 8, wherein the LTE RSRP threshold is (pre)configured per resource pool independently from a NR RSRP threshold list.

Example 10 is a baseband processor, including the subject matter of example 8, wherein the LTE RSRP threshold is (pre)configured per resource pool and the same as a NR RSRP threshold list.

Example 11 is a baseband processor, including the subject matter of example 8, wherein the LTE RSRP threshold is (pre)configured per resource pool based on a NR RSRP threshold list plus a (pre)configured RSRP offset or a (pre)configured list of RSRP offsets.

Example 12 is a baseband processor, including the subject matter of example 1, wherein the first UE is a receiver UE of the second TB, and the potential resource collision is determined if a difference of a first RSRP measurement of the reserved LTE sidelink resources of the third UE and a second RSRP measurement of the reserved NR sidelink resources of the second UE is larger than the LTE RSRP threshold.

Example 13 is a baseband processor, including the subject matter of example 12, wherein the LTE RSRP threshold includes a LTE relative RSRP threshold list that is (pre)configured per resource pool based on a data priority of the second UE and a data priority of the third UE and independently from a NR relative RSRP threshold list.

Example 14 is a baseband processor, including the subject matter of example 12, wherein the LTE RSRP threshold includes a LTE relative RSRP threshold list that is (pre) configured per resource pool and the same as a NR relative RSRP threshold list.

Example 15 is a baseband processor, including the subject matter of example 12, wherein the LTE RSRP threshold includes a LTE relative RSRP threshold list that is (pre)configured per resource pool based on a NR relative RSRP threshold list plus a (pre)configured RSRP offset or a (pre)configured list of RSRP offsets.

Example 16 is a baseband processor, including the subject matter of example 1, wherein the first UE is a receiver UE of the first TB, and the potential resource collision is determined if a difference of a first RSRP measurement of the reserved NR sidelink resources of the third UE and a second RSRP measurement of the reserved LTE sidelink resources of the second UE is larger than the LTE RSRP threshold.

Example 17 is a baseband processor, including the subject matter of example 16, wherein the LTE RSRP threshold includes a LTE relative RSRP threshold list that is (pre)configured per resource pool based on a data priority of the third UE and a data priority of the second UE and independently from a NR relative RSRP threshold list.

Example 18 is a baseband processor, including the subject matter of example 16, wherein the LTE RSRP threshold includes a LTE relative RSRP threshold list that is (pre)configured per resource pool and the same as a NR relative RSRP threshold list.

Example 19 is a baseband processor, including the subject matter of example 16, wherein the LTE RSRP threshold includes a LTE relative RSRP threshold list that is (pre)configured per resource pool based on a NR relative RSRP threshold list plus a (pre)configured RSRP offset or a (pre)configured list of RSRP offsets.

Example 20 is a baseband processor, including the subject matter of example 1, wherein the IUC indication signal also indicates a source of the potential resource collision including whether the potential resource collision is due to a LTE sidelink conflict or a NR sidelink conflict.

Example 21 is a baseband processor, including the subject matter of example 20, wherein the IUC signal indicates that resources of the same sub-channel in next one or more slots are also reserved based on a numerology of the LTE sidelink if the potential resource collision is indicated as due to the LTE sidelink conflict.

Example 22 is a baseband processor, including the subject matter of example 20, wherein the source of the potential resource collision is indicated using different PSFCH frequency resources.

Example 23 is a baseband processor, including the subject matter of example 20, wherein the IUC indication signal is transmitted on PSFCH including two bits information to indicate whether the collision is from LTE sidelink, NR sidelink, or either LTE sidelink or NR sidelink.

Example 24 is a baseband processor, including the subject matter of example 20, wherein the IUC indication signal is transmitted on PSFCH including one bit information to indicate whether the collision is from LTE sidelink or NR sidelink.

Example 25 is a baseband processor, including the subject matter of example 20, wherein the IUC signal indicates that resources of the same sub-channel in next one or more slots are also reserved based on a numerology of the LTE sidelink if the potential resource collision is indicated as due to the LTE sidelink conflict.

Example 26 is a method for a first user equipment (UE) to coordinate inter-UE sidelink communication. The method comprises obtaining configurations of resource pools for a new radio (NR) sidelink and a long-term evolution (LTE) sidelink, wherein the NR sidelink and the LTE sidelink are coexisted in a co-channel and have resources overlapped in time and frequency, sensing on the resources in the resource pools for both the NR sidelink and the LTE sidelink, receiving a resource reservation information on the NR sidelink from a second UE, the resource reservation information indicating NR. resources reserved by the second UE, determining a potential resource collision based on the received resource reservation information of the second UE and the sensed resources in the resource pools of the NR sidelink and the LTE sidelink, and selectively transmitting an inter-UE coordination (IUC) indication signal based on a priority level of the NR resources reserved by the second UE, a timeline restriction, or a capability of UE-B to receive the IUC indication signal.

Example 27 is a method, including the subject matter of example 26, wherein the IUC indication signal is transmitted to the second UE if the priority level of the NR resources reserved by the second UE is lower than that of the sensed resources in the resource pools of the NR sidelink and the LTE sidelink.

Example 28 is a method, including the subject matter of example 26, wherein the IUC indication signal is not transmitted if the priority level of the NR resources reserved by the second UE is larger than that of the sensed resources in the resource pools of the NR sidelink and the LTE sidelink.

Example 29 is a method for a first user equipment (UE) to coordinate inter-UE sidelink communication. The method comprises obtaining configurations of resource pools for a new radio (NR) sidelink and a long-term evolution (LTE) sidelink, wherein the NR sidelink and the LTE sidelink are coexisted in a co-channel and have resources overlapped in time and frequency, sensing on the resources in the resource pools for both the NR sidelink and the LTE sidelink including transmission of a first transport block (TB), receiving a resource reservation information on the NR sidelink from a second UE, the resource reservation information indicating NR resources reserved by the second UE for transmission of a second TB, determining a potential resource collision if the NR resources reserved by the second UE are fully or partially overlapped with LTE sidelink resources reserved by a third UE, and a reference signal received power (RSRP) measurement satisfies a LTE RSRP threshold, and transmitting an inter-UE coordination (IUC) signal to the second UE indicating the potential resource collision is determined.

Example 30 is a method, including the subject matter of example 29, wherein the first UE is a destination UE of the second TB, and the potential resource collision is determined if a RSRP measurement of the reserved LTE sidelink resources of the third UE is larger than the LTE RSRP threshold, and wherein the LTE RSRP threshold is based on a data priority of the second UE and a data priority of the third UE.

Example 31 is a method, including the subject matter of example 29, wherein the potential resource collision is determined if a difference of a first RSRP measurement of the reserved LTE sidelink resources of the third UE and a second RSRP measurement of the reserved NR sidelink resources of the second UE is larger than the LTE RSRP threshold.

Example 32 is a method, including the subject matter of example 29, wherein the LTE RSRP threshold includes a LTE relative RSRP threshold list that is (pre)configured per resource pool based on a NR relative RSRP threshold list plus a (pre)configured RSRP offset or a (pre)configured list of RSRP offsets.

Example 33 is a method, including the subject matter of example 29, wherein the IUC signal also indicates a source of the potential resource collision including whether the potential resource collision is due to a LTE sidelink conflict or a NR sidelink conflict; and wherein the IUC signal indicates that resources of the same sub-channel in next one or more slots are also reserved based on a numerology of the LTE sidelink if the potential resource collision is indicated as due to the LTE sidelink conflict.

Example 34 is user equipment (UE), comprising processor circuitry configured to cause the UE to perform the method of any of examples 26-33.

Example 35 is an apparatus for operating a user equipment (UE), the apparatus comprising: processor circuitry configured to cause the UE to perform the method of any of examples 26-33.

Example 36 is a non-transitory computer-readable memory medium storing program instructions, where the program instructions, when executed by a computer system, cause the computer system to perform the method of any of examples 26-33.

Example 37 is a computer program product, comprising program instructions which, when executed by a computer, cause the computer to perform the method of any of examples 26-33.

Example 38 is a method that includes any action or combination of actions as substantially described herein in the Detailed Description.

Example 39 is a method as substantially described herein with reference to cach or any combination of the Figures included herein or with reference to each or any combination of paragraphs in the Detailed Description.

Example 40 is a user equipment configured to perform any action or combination of actions as substantially described herein in the Detailed Description as included in the user equipment.

Example 41 is a network node configured to perform any action or combination of actions as substantially described herein in the Detailed Description as included in the network node.

Example 42 is a non-volatile computer-readable medium that stores instructions that, when executed, cause the performance of any action or combination of actions as substantially described herein in the Detailed Description.

Example 43 is a baseband processor of a user equipment configured to perform any action or combination of actions as substantially described herein in the Detailed Description as included in the user equipment.

Example 44 is a baseband processor of a network node configured to perform any action or combination of actions as substantially described herein in the Detailed Description as included in the user equipment.

1. A baseband processor for a first user equipment (UE), comprising:
a memory interface;
one or more processors coupled to the memory interface, and when executing instructions received via the memory interface, configured to cause the first UE to:
schedule transmission of a first transport block (TB);
receive a resource reservation message on a sidelink channel from a second UE, the resource reservation message indicating resources reserved by the second UE for transmission of a second TB for reception at the first UE;
determine a potential resource collision of half-duplex operation based on the scheduled transmission of the first TB and the reserved reception of the second TB; and
generate, for transmission to the second UE, an inter-UE coordination (IUC) indication signal indicating the determination of the potential resource collision.

2. The baseband processor of claim 1, wherein the potential resource collision is due to a scheduled NR sidelink transmission of the first UE.

3. The baseband processor of claim 1, wherein the potential resource collision is due to a scheduled LTE sidelink transmission of the first UE.

4. The baseband processor of claim 1, wherein the potential resource collision is due to a scheduled uplink transmission of the first UE.

5. The baseband processor of claim 1, wherein the IUC indication signal having has a priority value of the minimum of priority values of the first TB and the second TB.

6. The baseband processor of claim 5, wherein the first TB is on a NR sidelink.

7. The baseband processor of claim 5, wherein the first TB is on a LTE sidelink.

8. The baseband processor of claim 1, wherein the first TB is for an uplink transmission of the first UE, and wherein the IUC indication signal is transmitted on a physical sidelink feedback channel (PSFCH) and has a priority value.

9. The baseband processor of claim 8, wherein the priority value of the IUC indication signal is the minimum of a resource pool (pre)configured priority value of a resource pool containing the first TB and a priority value of the second TB.

10. The baseband processor of claim 8, wherein the priority value of the IUC indication signal is the minimum of a pre-defined or fixed priority value of the first TB and a priority value of the second TB.

11. The baseband processor of claim 8, wherein the priority value of the IUC indication signal is associated with a sidelink priority threshold (pre) configured per resource pool and according to a data type of the first TB.

12. The baseband processor of claim 8, wherein the priority value of the IUC indication signal is the minimum of a priority value of the second TB and a priority value (pre) configured or fixed for the first TB associated with a data type of the first TB, the priority value of the first TB is a sidelink priority threshold parameter or a fixed value based on the data type of the first TB.

13. A method for a first user equipment (UE) to coordinate inter-UE sidelink communication, comprising:
scheduling transmission of a first transport block (TB) for the first UE;
receiving a resource reservation message on a sidelink channel from a second UE, the resource reservation message indicating resources reserved by the second UE to transmit a second TB to the first UE;
determining a potential resource collision if the scheduled transmission of the first TB and the reserved reception of the second TB are overlapped;
comparing a first priority level of the first TB and a second priority level of the second TB; and
selectively transmitting an inter-UE coordination (IUC) indication signal to the second UE based on the comparison of the first priority level and the second priority level indicating the potential resource collision.

14. The method of claim 13, wherein the IUC indication signal is transmitted to the second UE if the first priority level is high than or equal to a second priority level of the second TB.

15. The method of claim 13, wherein the IUC indication signal is not transmitted if the first priority level is lower than the second priority level.

16. The method of claim 15, wherein the IUC indication signal is not transmitted if the first TB is scheduled on a sidelink with a higher priority value than a priority value of the second TB.

17. The method of claim 15, wherein the IUC indication signal is not transmitted if the first TB is scheduled on an uplink with a priority index associated with a data type; and wherein the second TB has a priority value below a sidelink priority threshold associated with the priority index or the data type.

18. The method of claim 17, wherein the IUC indication signal is not transmitted if:
the first TB has a priority index of 0, and the second TB has a priority value below a first sidelink priority threshold associated with the priority index of 0; or
the first TB has a priority index of 1, and the second TB has a priority value below a second sidelink priority threshold associated with the priority index of 1.

19-21. (canceled)

22. A method for a first user equipment (UE) to coordinate inter-UE sidelink communication, comprising:
scheduling transmission or reception of a first transport block (TB) on a LTE sidelink for the first UE;
receiving a resource reservation message on a new radio (NR) sidelink from a second UE, the resource reservation message indicating resources reserved by the second UE for transmission of a second TB;
determining a potential resource collision if the scheduled transmission or reception of the first TB and the reserved reception of the second TB are overlapped in time-and-frequency; and
transmitting an inter-UE coordination (IUC) indication signal to the second UE indicating the determination of the potential resource collision, wherein the IUC indication signal is transmitted on physical sidelink feedback channel (PSFCH) and has a priority value.

23. The method of claim 22, wherein the priority value of the IUC indication signal is the minimum of a priority value of the first TB and a priority value of the second TB.

24-26. (canceled)
